(19) United States
(12) Patent Application Publication
(10) Pub. No.: US 2025/0154297 A1
(43) Pub. Date: May 15, 2025

(54) PROCESS TO CREATE A THERMAL REVERSIBLE CROSSLINKING POLYPROPYLENE SYSTEM

(71) Applicant: SABIC GLOBAL TECHNOLOGIES B.V., Bergen op Zoom (NL)

(72) Inventors: Gert BOVEN, Steenbergen (NL); Klaas REMERIE, Maastricht (NL); Francesco PICCHIONI, Groningen (NL); Hendrik VERHOOGT, Maastricht (NL); Henky MULJANA, Bandung (ID)

(21) Appl. No.: 18/715,296

(22) PCT Filed: Dec. 8, 2022
(86) PCT No.: PCT/EP2022/084895

§ 371 Date: May 31, 2024

(30) Foreign Application Priority Data
Dec. 8, 2021 (EP) 21213205.4

(51) Int. Cl. C08F 8/32; C08F 8/34; C08J 3/24

(52) U.S. Cl. CPC C08F 8/32; C08F 8/34; C08J 3/24; C08F 2810/20; C08F 2810/50; C08J 2323/14; C08J 2351/06

(57) ABSTRACT

Process to create a thermal reversible crosslinking polypropylene system in the molten state, comprising at least the following step a) functionalization of a polypropylene grafted maleic anhydride (PPgMA) having a molecular weight of at least 9 kg/mol with an amine b) Crosslinking the functionalized polypropylene with bismaleimide to form a Diels Alder system.

### TECHNICAL FIELD OF THE INVENTION

The present invention relates to a crosslinking of polypropylene via the Diels Alder reaction using a bismaleimide bridge.

### TECHNOLOGICAL BACKGROUND OF THE INVENTION

Since the discovery of Ziegler Natta catalyst in 1954, polyolefin and in particular polypropylene (PP) was commercially produced in large scale worldwide and its production volume is increasing each year. Currently, PP has become one of the most essential thermoplastics in daily application.

This is not surprising, not only cause by its favorable price, but PP has superior properties compared with other thermoplastics material such as high toughness, good impact/rigidity profile, high tensile strength, good flexibility, low density, good chemical and heat resistance.

Therefore, PP has found its wide range of application in automotive, textile, household products, medical application, packaging and adhesives.

Despite of its superior properties, chemical modification of PP is still often required in order to improve some drawbacks in the properties and to expand its applicability in other areas.

Among other, the crosslinking of PP has gained a significant interest from many researchers worldwide.

The technology offers the possibility to improve temperature stability, to increase chemical resistance, to achieve high melt strength and to increase the mechanical resistance towards creep and stress cracking.

The conventional process to crosslink PP involves a macro radical formation through various possible routes for instance via thermal decomposition of peroxides, high energy irradiation (gamma and electron beams), ultraviolet (UV) radiation with UV sensitizer, and silane grafting with moisture crosslinking.

However, the current processes suffer from the degradation of the PP backbone and this further hinders commercial application of these technologies on the industrial scale.

In addition, all these approaches suffer from the drawback that the crosslinking, though necessary, is factually irreversible. This in stark contrast with the thermoplastic nature of the original polyolefin, which implicitly entails also the possibility to recycle the end-product which is not possible for crosslinked polymers.

Therefore, there is a strong incentive to find another possible route to produce a crosslinked PP with less degradation in the PP backbone and having the capability to reverse its crosslinking.

### SUMMARY

This object is achieved by the present invention. Accordingly, the present invention relates to a process to create a thermal reversible crosslinking polypropylene system in the molten state, comprising at least the following step:
a. Functionalization of a polypropylene grafted maleic anhydride (PPgMA) according to the formula 1

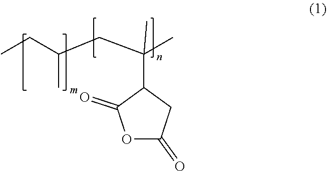

Wherein
n is 1 or higher
m is more than 200
with an amine according to the formula 2

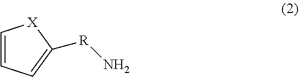

Wherein
X is an hetero atom (O or S)
R is selected from aliphatic hydrocarbon moieties which can include (—CH₂—)ₓ in which x>0, this moiety can optionally include heteroatoms like oxygen, nitrogen or sulphur,
b. Crosslinking the functionalized polypropylene with bismaleimide according to the formula 3

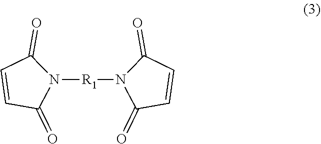

wherein R₁ is selected from an aliphatic or aromatic hydrocarbon moiety
wherein the bismaleimide and the grafted amine form a Diels Alder system
wherein the polypropylene grafted maleic anhydride has a molecular weight of at least 9 Kg/mol.

In another embodiment, the amine is selected from the group comprising furan and thiophene, more preferably furfurylamine and 2-thiophenemethylamine

In another embodiment, the polypropylene grafted maleic anhydride has a weight average molecular weight of more than 20000 g/mol and most preferable a weight average molecular weight of more than 50000 g/mol.

In another embodiment, the polypropylene grafted maleic anhydride comprise between 0.1 and 10 wt % of maleic anhydride in regard of the total weight of the polypropylene, preferably 0.2 to 5 wt %, most preferably 0.5 to 3 wt %

In another embodiment, the grafting yield of the amine on to the polypropylene grafted maleic anhydride is between 20 and 100% of the available maleic anhydride, more preferably between 50 and 100%, most preferably between 75 and 100%.

In another embodiment, the formation of the DA is performed under an annealing temperature between 5° and 170° C. during a period of 24 hours, more preferably between 8° and 160° C. and most preferably between 10° and 150° C.

In another embodiment, the storage modulus measured at 160° C. and 1 rad/s increased by at least a factor 100 upon modification, crosslinking and annealing and wherein this storage modulus is 400 Pa or higher

In another embodiment, the complex viscosity measured at 160° C. and 1 rad/s increased by at least a factor 40 upon modification, crosslinking and annealing and wherein this complex viscosity is 400 Pa·s or higher.

In another embodiment, the melting enthalpy upon crosslinking and annealing is not reduced by more than 10%

Another aspect of the invention is a thermal reversible crosslinking polypropylene system with high melt viscosity or high melt-strength in the molten state according to the formula 4

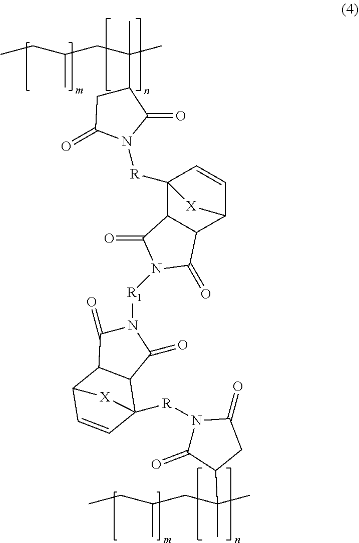

Wherein
n is 1 or higher
m is more than 200
X is an hetero atom (O or S)
R is selected from aliphatic hydrocarbon moieties which can include (—CH₂—)ₓ in which x>0, this moiety can optionally include heteroatoms like oxygen, nitrogen or sulphur wherein R₁ is selected from an aliphatic or aromatic hydrocarbon moiety

In another embodiment, X is S.

In another embodiment, X is O and wherein:
a. M_{w} of the PPgMA is more than 9 kg/mol determined by GPC according to the description
b. Complex melt viscosity measured at 160° C. and 1 rad/s determined by rheology according the description of at least 400 Pa·s
c. Storage modulus measured at 160° C. and 1 rad/s determined by rheology according the description of at least 400 Pa
d. The ratio of storage modulus over loss modulus (G′/G″) measured at 160° C. and 1 rad/s determined by rheology according the description of at least 2

In another embodiment, X is S and wherein:
a. M_{w} of the PPgMA is more than 9 kg/mol determine by GPC according to the description
b. Complex melt viscosity measured at 160° C. and 1 rad/s determined by rheology according the description of at least 10000 Pa·s
c. Complex modulus measured at 160° C. and 1 rad/s determined by rheology according the description of at least 10000 Pa.
d. The ratio of storage modulus over loss modulus (G′/G″) measured at 160° C. and 1 rad/s determined by rheology according the description of at least 2

Another aspect of the invention is use of the thermal reversible crosslinking polypropylene system according to the invention for glue applications, foaming applications, pipe applications, automotive bumper applications.

### DETAILED DESCRIPTION

The Inventor surprisingly discovered that a novel crosslinked polypropylene product can be achieved by using Diels Alder reactions (DA).

Indeed, at relatively low temperatures between 5° and 160° C., a ring is formed by a reaction between a diene and a dienofile. Allowing the creation of a suitable crosslinking network when those diene and/or dienofile are grafted onto a polypropylene.

Furthermore, a retro-Diels Alder reaction (rDA), i.e. opening the ring forming the diene and dienofile again, occurs at higher temperatures, preferably above the melting temperature of the used polyolefin, allowing to de-crosslink the polypropylene.

By using the reaction between a bis-maleimide and furan derivative inventors were able to form novel crosslinked polypropylene with less degradation in the PP backbone and having the capability to reverse its crosslinking.

### Polypropylene Grafted Maleic Anhydride (PPgMA)

In this application, polypropylene grafted maleic anhydride is polypropylene (PP) on which maleic anhydride was grafted according to formula 1.

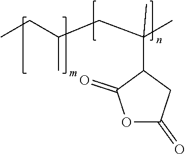

Wherein
n is 1 or higher
m is more than 200

Preferably the PPgMA comprises between 0.1 and 10 wt % of maleic anhydride in regard of the total weight of the polypropylene, preferably 0.2 to 5 wt %, most preferably 0.5 to 3 wt %.

Preferably the PPgMA has a weight average molecular weight of at least 9 kg/mol, preferably 20 Kg/mol, more preferably 50 kg/mol

In this application polypropylene (PP) means a homopolymer of propylene or a mixture of propylene and at least another olefin ranging from C₂ or C₄ to C₂₀ such as ethylene, 1-butene, 3-methyl-1-butene, 1-pentene, 4-methyl-1-pentene, 1-hexene, vinyl cyclohexane, 1-octene, norbornene, vinylidene-norbornene, ethylidene-norbornene, such as a propylene-based copolymer, e.g. heterophasic propylene-olefin copolymer; random propylene-olefin copolymer.

Advantageously, the mixture of propylene and at least another olefin comprises at least 50 wt % of propylene the rest is another olefin ranging from C₂ or C₄ to C₂₀, preferably ethylene, 1-butene, 3-methyl-1-butene, 1-pentene, 4-methyl-1-pentene, 1-hexene, vinyl cyclohexane, 1-octene, norbornene, vinylidene-norbornene, ethylidene-norbornene, preferably at least 60 wt. %, more preferably at least >70 wt. %, most preferably at least 80 wt. %, advantageously 90 wt %, more advantageously 99.7 wt %.

In some embodiment, PP can be a heterophasic propylene copolymer wherein the heterophasic propylene copolymer consists of:
(a) a propylene-based matrix, wherein the propylene-based matrix consists of a propylene homopolymer and/or a propylene copolymer consisting of at least 70 wt % of propylene and at most 30 wt % of ethylene and/or an α-olefin having 4-10 carbon atoms, based on the total weight of the propylene-based matrix and wherein the propylene-based matrix is present in an amount of 60 to 95 wt % based on the total heterophasic propylene copolymer and
(b) a dispersed ethylene-α-olefin copolymer, wherein the dispersed ethylene-α-olefin copolymer is an ethylene-propylene copolymer, wherein the ethylene-α olefin copolymer is present in an amount of 40 to 5 wt % based on the total heterophasic propylene copolymer and wherein the sum of the total amount of propylene-based matrix and total amount of dispersed ethylene-α-olefin copolymer is 100 wt %.

In some embodiment, PP can be a terpolymer meaning that it is a copolymer of three different olefin monomers comprising propylene and 2 other different olefins ranging from C₂ or C₄ to C₂₀, preferably ethylene, 1-butene, 3-methyl-1-butene, 1-pentene, 4-methyl-1-pentene, 1-hexene, vinyl cyclohexane, 1-octene, norbornene, vinylidene-norbornene, ethylidene-norbornene. In this embodiment the content of propylene is superior to the content of each of the other olefins separately, preferentially the amount of PP is superior to 70 wt %, preferentially 80 wt %, more preferentially 90 wt % based on the total terpolymer.

In some embodiment the PP may also contain one or more of usual additives, including stabilisers, e.g. heat stabilisers, anti-oxidants, UV stabilizers; colorants, like pigments and dyes; clarifiers; surface tension modifiers; lubricants; flame-retardants; mould-release agents; flow improving agents; plasticizers; anti-static agents; impact modifiers; blowing agents; fillers and reinforcing agents; and/or components that enhance interfacial bonding between PP and filler.

Besides the cross-linking/decross-linking temperatures, also the efficiency of the cross-linker is important, with a more efficient cross-linker, either higher cross-link densities can be reached or lower amounts of grafting are needed. The latter is beneficial for the final properties of the polyolefin (e.g. high grafting levels can lead to lower crystallinity) and add less costs.

Functionalization with Amine

The PPgMA is functionalized with an amine according to the formula 2

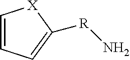

Wherein
X is an hetero atom (O or S), preferably S.
R is selected from aliphatic hydrocarbon moieties which can include (—CH₂—)ₓ in which x>0, this moiety can optionally include heteroatoms like oxygen, nitrogen or sulphur

According to some embodiment, the amine is a furan or a thiophene, more preferably furfurylamine or 2-thiophenemethylamine.

### Crosslinking the Functionalized Polypropylene

Crosslinking the functionalized polypropylene with bismaleimide according to the formula 3

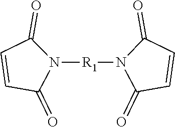

wherein R1 is selected from an aliphatic or aromatic hydrocarbon moiety, preferably the bismaleimidee is 1,1′-(methylenedi-4,1-phenylene)bismaleimide,
in order to form a DA and crosslinking the PP according to formula 4

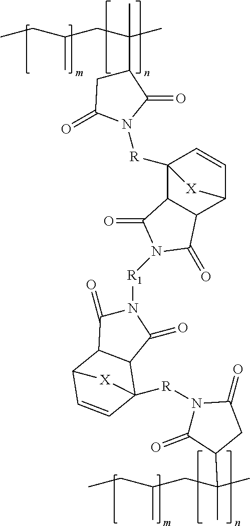

Wherein
n is 1 or higher
m is more than 200
X is an hetero atom (O or S)
R is selected from aliphatic hydrocarbon moieties which can include (—CH₂—)ₓ in which x>0, this moiety can optionally include heteroatoms like oxygen, nitrogen or sulphur
wherein R₁ is selected from an aliphatic or aromatic hydrocarbon moiety

In some embodiment, the complex melt viscosity measured at 160° C. and 1 rad/s:
when X is O: at least 300 Pa·s, preferably 400 Pa·s.
when X is S: at least 10000 Pa·s, preferably more than 12000 Pa·s.

In some embodiment, Storage modulus measured at 160° C. and 1 rad/s
when X is O: at least 300 Pa·s, preferably 400 Pa·s.
when X is S: at least 10000 Pa·s, preferably more than 12000 Pa·s.

In some embodiment, the ratio of storage modulus over loss modulus (G′/G″) measured at 160° C. and 1 rad/s of at least 2, in particular when X is O, and can be at least 10, preferably 12 when X is S.

### Examples

### Material

Polypropylene grafted maleic anhydride (PPgMA, average Mₙ 3900 g/mol, average M_{w} 9100 g/mol, and 8-10% wt maleic anhydride) from Aldrich (Germany).
Polypropylene grafted maleic anhydride with higher molecular weight produced by Exxon Mobil USA (PPgMASB, Mₙ 24 kg/mol, M_{w} 121 kg/mol and ˜0.9 wt % maleic anhydride).
Furfurylamine (FFA, >99%) Aldrich (Germany)
2-thiophenemethylamine (TMA, 96%) Aldrich (Germany)
1,1′-(methylenedi-4,1-phenylene)bismaleimide (BM, 95%) Aldrich (Germany)
tetrahydrofuran (THF, >99.9%) Aldrich (Germany)
chloroform (CHCl₃, >99%) from Aldrich (Germany).
1-2 dichlorobenzene (DCB, >99%) from Fluka (Germany).
Antioxidants AOB225 (CAS Number 9421-57-8).

### Synthesis of Functionalized and Cross-Linked Polypropylene Samples:

### Step 1: Functionalization of Maleic Anhydride Grafted PP.

Functionalization of polypropylene with amines: 15 grams of maleic anhydride grafted PP (PPgMA or PPgMASB) and 4 equivalent of the amine (FFA or Thiop) based on MA content in PPgMA or PPgMASB were mixed in a Brabender kneader for 10 minutes with rotational speed of 50 rpm and temperature of 160° C. The solid product was grinded and washed using boiling THF at 170° C. in a SOXTEC apparatus for 3 hours to remove the excess of the reagent. The samples were then dried in a vacuum oven at 50° C. until constant weight. Next, the dried products were compressed at 175° C. and 100 bar for 30 minutes to complete the reaction by closing the amine aromatic ring.

Step 2: Crosslinking of Functionalized Polypropylene with Bismaleimide (BM)

The functionalized polypropylene product (2 g), and 0.5 equivalent of BM based on the theoretical amount of furan or thiophene in the functionalized product were added into 25 ml of round bottom flask. Afterwards, chloroform (20 g) was added into the flask. The mixture was then stirred and heated at 50° C. in a water bath for 3 hours. The mixture was collected in the beaker glass and chloroform was separated from the product by slowly evaporation in the fume cabinet for 24 hours. The solid product was annealed at different temperatures (50, 120 or 150° C.) for 24 hours.

The products were coded as shown in Table 1 and Table 2:

TABLE 1
codes for furan functionalized samples

| | | | Cross-linked | Cross-linked |
|---|---|---|---|---|
| | Function- | Cross-linked | with BM, | with BM, |
| Grafted | alized | with BM, no | annealed | annealed |
| PP | with FFA | annealing | at 50° C. | at 120° C. |
| PPgMA | FG0 | FG1 | FG1A50 | FG1A120 |
| PPgMASB | FGSBO | FGSB1 | FGSB1A50 | FGSB1A120 |

TABLE 2
codes for thiophene functionalized samples

| | | | Cross-linked | Cross-linked |
|---|---|---|---|---|
| | Function- | Cross-linked | with BM, | with BM, |
| Grafted | alized | with BM, no | annealed | annealed |
| PP | with Thiop | annealing | at 50° C. | at 150° C. |
| PPgMA | TG0 | TG1 | TG1A50 | TG1A150 |
| PPgMASB | TGSB0 | TGSB1 | TGSB1A50 | TGSB1A150 |

PPgMA was used because the high MA grafting level allowed standard analytical methods like FTIR and elemental analysis to be used with good accuracy. The degree of functionalization of each precursor was calculated from the molar ratio of the nitrogen (N) in the intermediate products with the molar ratio of MA in the PPgMA. Elemental analysis was performed to measure the content of C, H, N and S of the intermediate products. Table 3 shows the elemental analysis of the starting material and the intermediate products. The low value of N content of FGSB0 compared to the other products is a result of the low maleic anhydride level of the product.

TABLE 3
C, H, N, S composition of the PPgMA and the intermediate products

| | N % | C % | H % | S % | MAH mol % | MAH wt % | % conversion |
|---|---|---|---|---|---|---|---|
| PPgMA | <0.01 | 81.93 | 13.70 | | 0.091 | 8.9 | |
| PPgMASB | <0.01 | 85.16 | 14.56 | | 0.0059 | 0.58 | |
| FG0 | 0.34 | 84.62 | 13.77 | | | | 26.3 |
| FGSB0 | 0.08 | 85.75 | 14.11 | | | | 96.2 |
| TG0 | 0.38 | 83.92 | 13.88 | 1.14 | | | 29.8 |

Functionalization of PPgMA with FFA and Thiop (FG0 and TG0) was shown by the change of carbonyl group absorptions (C═O) in FTIR. The typical C═O absorption of grafted maleic anhydride appears at 1768 cm⁻¹ and was reduced in the functionalized products FG1 and TG1 whereas the C═O absorption peak of the imide product at 1700 cm⁻¹ appeared.

Adding BM results in an additional peak at 1510 cm⁻¹ corresponding with the unsaturated bond (C═C) of maleimide rings in BM and a peak at 3100 cm⁻¹. The appearance of a peak at 1186 cm⁻¹, assigned to a C—O—C vibration suggests the formation of the DA adduct.

The extent of the DA crosslinking reaction can be followed by FTIR (Polgar et al, Macromolecules (2015) 48, 7096). Decreasing absorption of the bis-maleimide double bond ring at 1510 cm⁻¹ and increasing absorptions of peak 1186 cm⁻¹ attributed to the furan-maleimide and thiophene-maleimide cyclo-adduct is a measurement of cross-link formation. The peak at 1707 is ascribed to C═O in BM rings and is chosen as the standard as the intensity remains constant. Peak de-convolution allows quantification by calculating the ratio's of the peaks at 1510 cm⁻¹ and 1186 cm⁻¹ versus the reference peak at 1707 cm⁻¹ The results in Table 4 show that the ratio of 1510/1707 decreases while the one of 1186/1707 increases upon annealing with increasing temperature. In view of the peak assignment discussed above, this clearly indicates the increasing formation of the cyclo-adducts with increasing temperature.

The lower values of the FGSB1 series versus those of the FG1 series are a result of the lower grafting level of PPgMASB versus PPgMA.

TABLE 4
Intensity ratio of furan bismaleimides DA peaks

| | Ratio 1510/1707 | Ratio1186/1707 |
|---|---|---|
| FG1 | 0.377 | 0.077 |
| FG1A50 | 0.329 | 0.117 |
| FG1A120 | 0.255 | 0.618 |
| FGSB1 | 0.220 | 0 |
| FGSB1A50 | 0.217 | 0 |
| FGSB1A120 | 0.270 | 0.066 |
| TG1 | 0.289 | 0 |
| TG1A50 | 0.252 | 0.099 |
| TG1A150 | 0.164 | 0.296 |

Crosslinking Leads to Modified Properties, e.g. Different Rheological Properties.

Typical properties are storage modulus (G′) and complex viscosity (eta*) measured with rheology. The data shown in Table 5 and 6 are measured at 160° C. at various frequencies.

Table 5 shows the storage modulus (G′) and loss modulus (G″) in Pa at 160° C. for two frequencies. As can be seen, upon annealing G′ increases. The effect is clearly seen in the highly functionalized materials of series FG1 and TG1 but in the series FGSB1 the effect is negligible. The FG1 series shows a gradual increase of G′ upon annealing at higher temperatures, however the TG1 series do not change after annealing at 50° C. but lead to a large increase of G′ after annealing at 150° C. Grafting yields of FG1 and TG1 are similar (26.3 versus 29.8%: Table 3) which should theoretically lead to a comparable crosslink density. However, G′ of TG1A150 is much higher than that of FG1A120 which is an indication that at the test temperature of 160° C. the thiophene/bismaleimid system is more crosslinked than the furan/bismaleimid system. The grafting level of PPgMASB is rather low and therefore not many crosslinks are likely to be created as can be seen in the limited increase of G′ for FGSB1A120. Surprisingly the thiophene system does give an increase of G′ after annealing at 150° C., but the values are below that of the low molecular weight PP counterpart as can be seen by comparing TGSB1A150 with TG1A150.

Not only G′ is indicating crosslinking but also the ratio G′/G″. When this ratio is more than 1 the material is believed to be a solid. For PPgMA this ratio is below 1. Functionalization with furan groups with subsequent addition bismaleimide crosslinking agent and annealing leads to ratios above 1 which increase more after annealing, as can be seen from FG1, FG1A50 and F1GA120, indicating increased crosslinking. It has been observed that thiophene modification after annealing at 50° C. does not give a ratio above 1. However annealing at 150° C. leads to a ratio above 1. Lowering the degree of functionalization does not show an increased ratio with furan modification (FGSB series). Thiophene modification however does give a ratio above 1 after annealing at 150° C.

TABLE 5
Storage modulus (G′), loss modulus (G″) bothin Pa and
ratio G′/G′at 160° C. versus frequency

| | Frequency [rad/s] | | | | | |
|---|---|---|---|---|---|---|
| | 0.1 rad/s | | | 1 rad/s | | |
| | G′ [Pa] | G″ [Pa] | G′/G″ | G′ [Pa] | G″ [Pa] | G′/G″ |
| PPgMA | 0.2 | 0.4 | 0.6 | 1.1 | 2 | 0.6 |
| FG1 | 2.8 | 1.6 | 1.7 | 5.9 | 7 | 0.9 |
| FG1A50 | 108 | 38 | 2.8 | 57 | 37 | 1.5 |
| FG1A120 | 250 | 80 | 3.1 | 400 | 141 | 2.8 |
| TG1 | 0.01 | 0.1 | 0.1 | 0.3 | 0.9 | 0.3 |
| TG1A50 | 0.01 | 0.2 | 0.1 | 0.5 | 1.3 | 0.4 |
| TG1A150 | 11754 | 892 | 13.2 | 12818 | 934 | 13.7 |
| PPgMASB | 1.7 | 11 | 0.2 | 10 | 93 | 0.1 |
| FGSB1 | 1.0 | 21 | 0.0 | 24 | 221 | 0.1 |
| FGSB1A50 | 0.7 | 26 | 0.0 | 25 | 243 | 0.1 |
| FGSB1A120 | 1.8 | 31 | 0.1 | 40 | 267 | 0.1 |
| TGSB1 | 0.3 | 14 | 0.0 | 8.6 | 134 | 0.1 |
| TGSB1A50 | 0.3 | 15 | 0.0 | 9.5 | 150 | 0.1 |
| TG1SB1A150 | 3509 | 3007 | 1.2 | 3298 | 2088 | 1.6 |

Table 6 shows the complex viscosity (eta*) in Pa·s at 160° C. versus frequency. The effects are similar to those of G′ shown in Table 5. As can be seen eta* increases upon annealing FG1 at 50° C. and increases more upon annealing at 120° C. Annealing TG1 at 50° C. does not lead to higher viscosity but at 150° C. the effect is large. Eta* of TG1A150 is much higher than that of FG1A120 whereas the functionalization degree is similar and crosslink degree is expected to be comparable. Just as for the effect of G′ shown in Table 5 it is an indication that at the test temperature of 160° C. the thiophene/bismaleimid system is more crosslinked than the furan/bismaleimid system. The viscosity increase of annealing the low functionalized materials based on PPgMASB is much smaller. The viscosity of FGSB1A120 is only slightly higher than that of starting material PPgMASB. The grafting level of the FGSB1 series is rather low and therefore not many crosslinks can be created leading to the low increase of eta*. Crosslinking with thiophene however shows increased viscosity after annealing at 150° C.

TABLE 6
Complex viscosity (eta*) in Pa · s at 160° C. versus frequency

| Frequency [rad/s] | 0.1 | 1 | 100 |
|---|---|---|---|
| PPgMA | 4.2 | 2.0 | 28 |
| FG1 | 32 | 9.2 | 30 |
| FG1A50 | 1147 | 68 | 30 |
| FG1A120 | 2636 | 426 | 42 |
| TG1 | 1.0 | 1.0 | 30 |
| TG1A50 | 1.7 | 1.4 | 30 |
| TG1A150 | 118371 | 12906 | 193 |
| PPgMASB | 111 | 94 | 75 |
| FGSB1 | 211 | 224 | 119 |
| FGSB1A50 | 263 | 245 | 135 |
| FGSB1A120 | 311 | 271 | 136 |
| TGSB1 | 136 | 134 | 94 |
| TGSB1A50 | 152 | 150 | 101 |
| TGSB1A150 | 46406 | 3920 | 162 |

The relatively high G′ and eta* of the very low molecular weight polymer TG1A150 could be an indication for permanent crosslinks which could lead to issues in melt processing. MVR tests at very mild conditions for polypropylene (170° C.) show a very high result indicating that TG1A150 is melt processable. The MVR data of the uncrosslinked samples PPgMA and TG1 had even higher results, outside the range of the test, indicating that some cross-linking or branching was still present in the melt of TG1A150 at 170° C.

TABLE 7
MVR data of TG1 series

| | Load [kg] | Temperature[° C.] | MVR [cc/10 min] |
|---|---|---|---|
| PPgMA | 2.16 | 170 | >200 |
| TG1 | 2.16 | 170 | >200 |
| TG1A150 | 2.16 | 170 | 79 |

DSC data show that the crystallinity changes slightly upon crosslinking. Tm decreases by a few degrees, Tc increases by a few degrees and melting enthalpies of PPgMA and TG1A150 are similar, indicating that the overall crystallinity has hardly changed.

TABLE 8
DSC data of TG1 series

| | Tm [° C.] | Tc [° C.] | Delta Hm [J/g] | Delta Hc [J/g] |
|---|---|---|---|---|
| PPgMA | 155.2 | 107.8 | 63.4 | 71.6 |
| FG1A120 | 150.0 | 120.2 | 59.4 | 62.4 |
| TG1A150 | 149.1 | 114.3 | 63.5 | 69.6 |

### Analytical Equipment and Methods

The FT-IR spectra was acquired on a Shimadzu IRTracer-100 equipped with an attenuated total reflectance (ATR) Golden Gate apparatus (Graseby-Specac Ltd., Orpington, UK) with a diamond crystal. FT-IR measurements were done with 64 scans in the absorption range of 4000 to 500 cm−1 with a resolution of 4 cm−1 and averaging 64 scans. The spectra were deconvoluted (R>0.95) to calculate the change in the intensity of the relevant peaks.

TGA analysis were done on Perkin Elmer TGA 4000. The samples were heated to 700° C. in an inert atmosphere with a heating rate of 10° C. min-1.

DSC analysis were performed using a Perkin Elmer DSC 7. The samples (10 mg) were heated from 2° C. to 250° C. with a heating rate of 5° C. min-1 and cooled back to 25° C. with a cooling rate of 5° C. min−1. The heating and cooling step was done in two cycles. The first cycle was done to remove thermal history from the material.

The GPC measurements were performed on a Polymer Laboratories PL-GPC 210 equipped with 4 Agilent Technologies PLgel 20 μm MIXED-A, 7.5×300 mm columns. The GPC was operated at temperature of 150° C. with 1,2,4 trichlorobenzene as the solvent.

Elemental analysis for C, H, N, and S was performed using a Euro EA 3000 Eurovector S.P.A Elemental Analyzer.

The rheology of the materials were measured using Haake Mars Ill (Thermo Fisher Scientific) equipped with Controlled Test Chamber (CTC). The sample specimen (diameter of 2.5 cm and thickness of 1 mm) was prepared with compression molding using a Taunus Ton press type VS up 150 A at 155° C. for 10 minutes and subsequently the press was cooled to room temperature using cooling water for approximately 20 minutes. The shear rheology was measured using 1% of strain which is in the linear viscoelastic regime for all samples Frequency sweep experiments were done in the frequency range of 0.01-100 rad/s and temperature of 160° C. The storage modulus (G′), loss modulus (G″) and the complex viscosity (|η*|) were measured as functions of temperature and ω.

MVR was measured on a Zwick-Roell MVR tester according ISO1133 at the temperatures shown in the tables and a load of 2.16 kg.

1. A process to create a thermal reversible crosslinking polypropylene system in the molten state, comprising at least the following step:
a. functionalization of a polypropylene grafted maleic anhydride (PPgMA) according to the formula 1 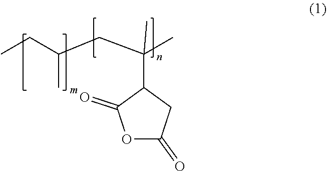
wherein
n is 1 or higher,
m is more than 200,
with an amine according to the formula 2 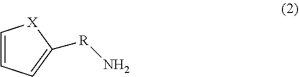
wherein
X is an hetero atom,
R is selected from aliphatic hydrocarbon moieties which can include —CH₂—ₓ in which x>0, this moiety can optionally include heteroatoms like oxygen, nitrogen or sulphur,
b. crosslinking the functionalized polypropylene with bismaleimide according to the formula 3 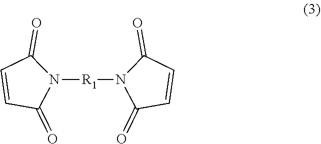
wherein R₁ is selected from an aliphatic or aromatic hydrocarbon moiety
wherein the bismaleimide and the grafted amine form a Diels Alder system
wherein the polypropylene grafted maleic anhydride has a molecular weight of at least 9 kg/mol, and
wherein the formation of the DA is perform under an annealing temperature between 50 and 170° C. during a period of 24 hours.

2. The process according to claim 1 wherein the formation of the DA is perform under an annealing temperature between 80 and 160° C. during a period of 24 hours.

3. The process according to claim 1, wherein the amine is selected from the group comprising furan and thiophene.

4. The process according to claim 1, wherein the polypropylene grafted maleic anhydride has a weight average molecular weight of more than 20000 g/mol.

5. The process according to claim 1 wherein the polypropylene grafted maleic anhydride comprise between 0.1 and 10 wt % of maleic anhydride in regard of the total weight of the polypropylene.

6. The process according to claim 1, wherein the grafting yield of the amine on to the polypropylene grafted maleic anhydride is between 20 and 100% of the available maleic anhydride.

7. The process according to claim 1, wherein the shear modulus measured at 160° C. and 1 rad/s increased by at least a factor 100 upon modification, crosslinking and annealing and wherein this shear modulus is 400 Pa or higher.

8. The process according to claim 1, wherein the viscosity measured at 160° C. and 1 rad/s increased by at least a factor 40 upon modification, crosslinking and annealing and wherein this viscosity is 400 Pa·s or higher.

9. The process according to claim 1, wherein the melting enthalpy upon crosslinking and annealing is not reduced by more than 10%.

10. A thermal reversible crosslinking polypropylene system with high melt viscosity or high melt-strength in the molten state according to the formula 4 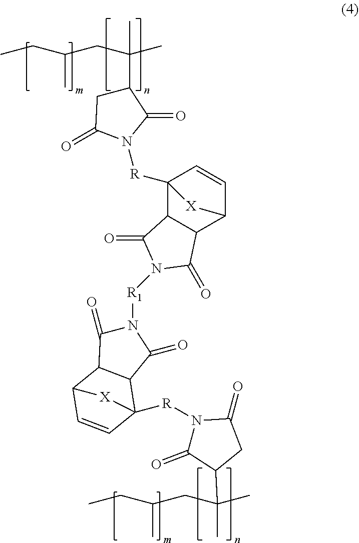
wherein
n is 1 or higher,
m is more than 200,
X is an hetero atom, and
R is selected from aliphatic hydrocarbon moieties which can include (—CH₂—)ₓ in which x>0,
this moiety can optionally include heteroatoms like oxygen, nitrogen or sulphur, and
wherein R₁ is selected from an aliphatic or aromatic hydrocarbon moiety.

11. The thermal reversible crosslinking polypropylene system according to claim 10 wherein X is S.

12. The thermal reversible crosslinking polypropylene system according to claim 10, wherein X is O and wherein:
a. M_{w} of the PPgMA is more than 9 kg/mol determine by GPC according to the description
b. Complex melt viscosity measured at 160° C. and 1 rad/s determined by rheology according the description of at least 400 Pa·s
c. Storage modulus measured at 160° C. and 1 rad/s determined by rheology according the description of at least 400 Pa.
d. The ratio of storage modulus over loss modulus (G′/G″) measured at 160° C. and 1 rad/s determined by rheology according the description of at least 2.

13. The thermal reversible crosslinking polypropylene system according to claim 10, wherein X is S and wherein:
a. M_{w} of the PPgMA is more than 9 kg/mol determine by GPC according to the description
b. Complex melt viscosity measured at 160° C. and 1 rad/s determined by rheology according the description of at least 10000 Pa·s
c. Complex modulus measured at 160° C. and 1 rad/s determined by rheology according the description of at least 10000 Pa.
d. The ratio of storage modulus over loss modulus (G′/G″) measured at 160° C. and 1 rad/s determined by rheology according the description of at least 2.

14. An article comprising the thermal reversible crosslinking polypropylene system according to claim 10.
